(19) United States
(12) Patent Application Publication
(10) Pub. No.: US 2009/0011389 A1
(43) Pub. Date: Jan. 8, 2009

(54) SIMPLIFIED PORTABLE IN-THE-VEHICLE ROAD SIMULATOR

(76) Inventor: Konstantin SIZOV, Alexandria, VA (US)

Correspondence Address: HOUSTON ELISEEVA, 4 MILITIA DRIVE, SUITE 4, LEXINGTON, MA, 02421, US

(21) Appl. No.: 12/211,143

(22) Filed: Sep. 16, 2008

Related U.S. Application Data
(63) Continuation of application No. PCT/US2007/064324, filed on Mar. 19, 2007.
(60) Provisional application No. 60/783,313, filed on Mar. 17, 2006.

(51) Int. Cl. G09B 9/042

(52) U.S. Cl. 434/66; 434/69; 348/121

(57) ABSTRACT

The portable simulation system is a computer-based driving simulator, which uses an actual drive-by-wire vehicle as an input device, and a portable display to present a simulated Virtual Driving Environment (VDE) to the driver. The vehicle remains immobile with engine switched off. Embedded vehicle sensors are being used as simulator controls connecting to a portable computer via OBD II or similar on-board interface. A portable computer runs simulation software or a computer game. Electronic suspension actuators, wherever available, may be used to improve simulation experience by providing a limited vehicle tilt motion. Certain on-board vehicle's computers, including computers for mapping, gaming or entertainment, may be used to run simulation software, thereby reducing the simulator to a software application. Described driving simulator does not require external power source and can be operated at any parking space using any drive-by wire vehicle, including driver's own vehicle.

### RELATED APPLICATIONS

This application is a Continuation of PCT application serial number PCT/US2007/064324, filed on Mar. 19, 2007, which claims the benefit under 35 USC 119(e) of U.S. Provisional Application No. 60/783,313, filed on Mar. 17, 2006, both of which are incorporated herein by reference in their entirety.

### BACKGROUND OF THE INVENTION

The need in driving simulators for research, training and assessment applications has been widely recognized.

A typical driving simulator consists of a set of controls—a steering wheel and a set of pedals connected to a computer running simulation software or a computer game. Software responds to a driver manipulating the controls and displays a simulated view from the windshield of the simulated vehicle to the driver.

The simulator controls may be as simple as a joystick or a computer-game steering wheel connected to a personal computer and using a single display, or as elaborate as an actual cut-off cab of an actual vehicle surrounded by a number of large screen displays. The latter is usually referred to as a full-cab driving simulator.

While full-cab driving simulators have shown to be effective and widely used in research, industry and military applications, the cost of such simulators remains very high as re-creating a vehicle's cockpit is expensive and provides a very limited flexibility for later changes.

So the invention was made by the inventor to leverage hardware which is already built in into every vehicle and is therefore available at a location of convenience. The relevant description of that invention can be found in U.S. patent application Ser. No. 10/742,613 to K. Sizov, which is incorporated herein by reference in its entirety.

It is a portable system for driving simulation coupled with an actual vehicle. In operation, a driver/trainee uses an actual vehicle to drive up on a two-piece ramp. It should be appreciated that the driver can use any actual vehicle, including his or her own vehicle to receive the desired training or testing. The choice of a vehicle provides the driver with an advantage to receive training in and get used to the vehicle that the driver will be actually driving after completing the training program. It should also be noted that the terms “driver”, “student”, “user” and “trainee” are used throughout this description interchangeably.

After the steered front wheels of a vehicle are positioned on the top of turntables, the engine of the vehicle is tuned off. Each turntable can rotate around its own vertical axis, following the steering movements of the steered wheels.

While the vehicle is immobile and its power steering is not active, turntables allow the driver/trainee to operate the steering wheel of the vehicle without applying excessive force as compared to usual driving. In most vehicles an excessive force would have been necessary on the actual road due to the friction between the steered wheels and the surface of the road while the vehicle is immobile. Since the engine of the vehicle is not running during the simulation, the power steering is not active.

The steering wheel returns to its approximately central position driven by the natural forces resulting from exerting the weight of the vehicle to the Steering Angle Inclination (SAI) of the steered wheels.

Inside the vehicle an optional brake pedal sensor and actuator can be positioned under or clipped onto a brake and gas pedals. The said optional sensors are used when the vehicle's own built-in brake pedal and gas pedal sensors are not available. An optional actuator coupled to the brake pedal can be used to simulate an anti-lock brake (ABS) pulsation.

A portable computer receives input data from the sensors reading real-time state of the vehicle controls. A portable computer, such as a notebook computer having built-in 3D graphics processor can be used. The computer processes the input data and generates a Virtual Driving Environment (VDE) to be presented to the driver using a Head-Mounted Display (HMD) and a set of headphones. Alternatively, other forms of portable displays can be employed, such as LCD screens pasted on the inside of the vehicle's windows, as well as a set of external speakers might be used. The VDE is presented to the driver in the field of view corresponding to the head orientation of the driver provided by the head tracker built-into the HMD.

In the preferred embodiment the software is running on a portable computer powered by the battery of the vehicle or by the computer's own battery, therefore eliminating the need in an external power source.

### SUMMARY OF THE INVENTION

Further progress of automotive technologies permits deeper leverage of the vehicle's built-in equipment for the purposes of driving simulation as described here. It leads to further simplification of the simulator itself, which in turn, may lead to significant cost savings resulting in wider proliferation of simulated driver training and testing, ultimately saving driver's lives on the road.

Drive-by wire technologies eliminate the need for the turntables and pedal sensors for driving simulation permitting the leverage of more internal vehicle functionality for the purpose of driving simulation.

The present invention provides an in-vehicle driving simulation system without any need for under-the-steered-wheels mechanical devices, such as turntables, without a need for external sensors for reading a real-time state of vehicle's controls, when used with a drive-by-wire vehicle, with said sensors being a part of the vehicle itself, and when the torque from the steering wheel may be mechanically disconnected from the steered wheels of a vehicle while said vehicle is immobile, and when a Simulation Computer, running software, simulating Virtual Driving Environment (VDE), with a Head Mounted Display (HMD) or other audio and visual devices is attached to the vehicle's on-board interface bus, such as OBD II.

In particular, in the driving simulator of the present invention the simulation computer may be incorporated into the HMD.

Also more specifically, in the driving simulator of the present invention simulation computer can be a part of the vehicle or a vehicle's entertainment system. In that case the VDE is generated by an embedded software application running on said computer. The driving simulator of the present invention can use the vehicle's electronic suspension actuators to achieve a simulated limited tilt motion effects during driving simulation.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic illustration of the simplified simulator;

FIG. 2 is a block diagram of the simulator.

### DETAILED DESCRIPTION OF THE PREFERRED EMBODIMENTS

For any drive-by-wire vehicle without a mechanical link between the steering wheel and the steered wheels of the vehicle, the following driving simulator is proposed.

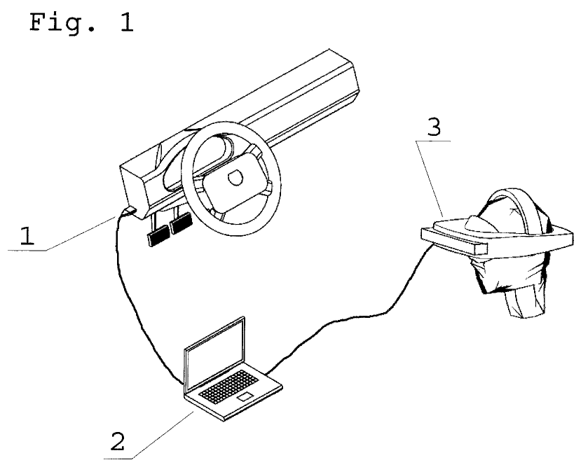

Turning now to FIG. 1, the in-vehicle driving simulator is reduced to a portable simulation computer 2 with audio and visual means 3 and an electronic computer-to-vehicle interface 1.

Audio and visual means normally consist of a head-tracked Head-Mounted Display (HMD) and a set of headphones. Alternatively, other forms of portable displays can be employed, such as flat or flexible LCD/Plasma/OLED or other screens pasted on the inside of the vehicle's windows, as well as a set of external speakers might be used.

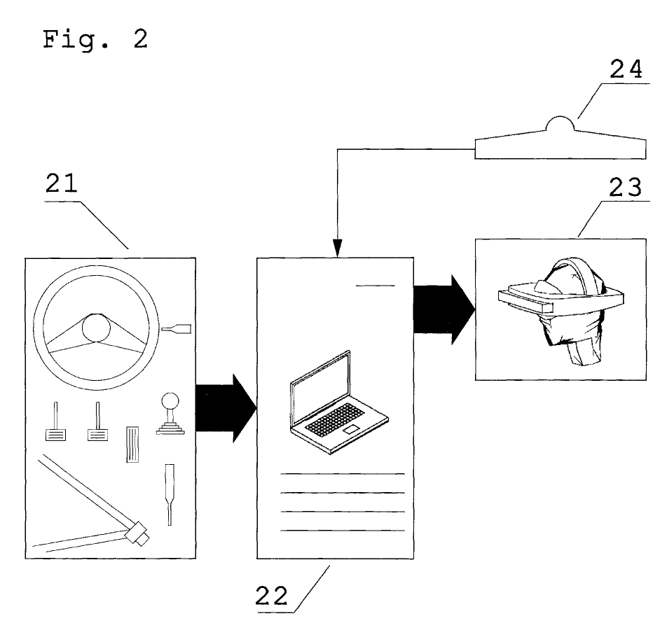

FIG. 2 shows a high-level block diagram of the portable simulator. As shown in FIG. 2, computing means 22 receive input data from the vehicle's controls 21. A portable computer, such as a notebook computer having built-in 3D graphics processor can be used as computing means. The computer processes the input data and generates a Virtual Driving Environment (VDE) to be presented to the driver using audio and visual means 23. Audio and visual means normally consist of a Head-Mounted Display (HMD) and a set of headphones. Alternatively, other forms of portable displays can be employed, such as LCD screens pasted on the inside of the vehicle's windows, as well as a set of external speakers might be used.

A portable computer 22 receives input data from the vehicle's controls 21 using OBD II or similar on-board diagnostic interface.

Real-time outputs of the most of the vehicle's sensors, including pedal sensors are available via OBD II (“On-Board Diagnostics”, at the time of this writing, OBD II is a most common standard for a diagnostics connector) or similar on-board diagnostic interface bus, using CAN (“Controller Area Network”, at the time of this writing, CAN is a most common protocol for data exchange between sensors and computers inside a vehicle) or other interface protocol. Vehicle's connection to a portable computer is facilitated by the interface hardware, which is widely commercially available from multiple vendors. An example of such vendor at the time of this writing is Dearborn Group, Inc.

VDE is presented to the driver as an image on the computer screen or an HMD showing the road that the driver is driving on. Such a view is changing in real time reflecting current simulated vehicle position as driver approaches road intersections, observes other vehicles and various other objects.

When a driver turns his/her head to the right/left he/she should be able to see the view of the road as he/she would be seeing it looking to the right/left in a real life. To facilitate this change of computer screen view depending on the position of the driver's head, the head tracker 24 is employed. The VDE is presented to the driver in the field of view corresponding to the head orientation of the driver provided by the head tracker 24.

In most common computer games, similar change of a field of view is performed by moving a mouse and referred to as a “mouse view”, that allows a player to pan his/her field of view to the left or to the right by moving a mouse. Using a head tracker instead of a mouse provides for a more realistic simulated experience and for better transfer of skills, since computer responds to the natural movements of the head similar to the one observed during an actual driving.

Audio means, such as headphones or loudspeakers are used to convey audio cues to the driver. Such cues include, but not limited to: engine noise, wind noise, tire screech when appropriate, as well as voice instructions for a given driving road exercise or a test.

In summary, the components that are required to create a driving simulator, using a drive-by-wire vehicle are a computer 2 running simulation software or a game and a Head-Mounted Display (HMD) 3.

Furthermore, Audio and Visual means in some cases may be built into a vehicle already. Such as head-up driver displays projecting on the windshield and built-in stereo systems.

The above will reduce a driving simulator even further to just a portable computer with an appropriate interface to the vehicle's equipment.

Even further—as more and more powerful computers become integrated into vehicles, including computers for gaming and entertainment, it will become possible to run computer simulations using a vehicle's on-board computer.

At that time the driving simulator may be reduced to an embedded software application running on a vehicle's on-board computer or an entertainment system.

Additionally electronic suspension actuators of newer vehicles may be used to improve simulation experience by providing a limited simulated tilt motion.

While this invention has been particularly shown and described with references to preferred embodiments thereof, it will be understood by those skilled in the art that various changes in form and details may be made therein without departing from the scope of the invention encompassed by the appended claims.

What is claimed is:

1. An in-vehicle driving simulation system comprising:
a simulation computer with software simulating a virtual driving environment, the simulation computer being coupled to an audio-visual device serving to present the virtual driving environment to a user;
an on-board electronic computer-to vehicle interface of a drive-by-wire vehicle, the computer-to-vehicle interface coupled to the simulation computer via a vehicle onboard interface bus;
wherein when the in-vehicle driving simulation system is in operation, the vehicle is immobilized, a torque of a steering wheel of the vehicle is mechanically disconnected from the wheels of the vehicle, and wherein the embedded vehicle sensors are used for reading a real time state of vehicle's controls.

2. The in-vehicle driving simulator system of claim 1, wherein the audio-visual device comprises a head mounted display.

3. The in-vehicle driving simulator system of claim 2, where the simulation computer is incorporated into the head mounted display.

4. The in-vehicle driving simulator system of claim 1, where the simulation computer is integrated in the vehicle or an entertainment system of the vehicle and the virtual driving environment is generated by an embedded software application running on the simulation computer.

5. The in-vehicle driving simulator system of claim 1, further employing electronic suspension actuators of the vehicle to achieve a simulated limited tilt motion effect during driving simulation.

6. The in-vehicle driving simulator system of claim 1, where the simulation computer is an on-board computer of the vehicle integrated into the vehicle for mapping, gaming, entertainment or other purposes.

7. The in-vehicle driving simulator system of claim 1, where a stereo system and a heads-up display integrated in the vehicle comprise the audio-visual device.

8. The in-vehicle driving simulator system of claim 1, wherein a stereo system and a heads-up display integrated in the vehicle comprise the audio-visual device and wherein the simulation computer is an on-board computer of the vehicle integrated into the vehicle, thereby reducing the driving simulator to a software application.
